(19) United States
(12) Patent Application Publication
(10) Pub. No.: US 2020/0317564 A1
(43) Pub. Date: Oct. 8, 2020

(54) ARTICLE HAVING AMPHIPHOBIC COATING FILM AND METHOD FOR PREPARATION THEREOF

(71) Applicant: RHODIA OPERATIONS, Paris (FR)

(72) Inventors: Cong Yu BAO, Shanghai (CN); Ling QI, Cestas (FR); Marie-Béatrice MADEC, Marneffe (BE)

(21) Appl. No.: 16/305,149

(22) PCT Filed: May 30, 2016
(86) PCT No.: PCT/CN2016/083877

§ 371 Date: Nov. 28, 2018

(51) Int. Cl. C03C 17/00; C08K 3/22; C08K 9/06; C08G 18/50; C09D 5/00; C09D 7/62

(52) U.S. Cl. CPC C03C 17/009; C08K 3/22; C08K 9/06; C08G 18/5015; C09D 5/00; C08K 2003/2296; C03C 2217/445; C03C 2217/475; C03C 2217/76; C03C 2217/77; C08K 2003/2213; C09D 7/62

(57) ABSTRACT

The present invention relates to an article comprising a substrate at least partially coated with a composition comprising solid in the form of aggregate and (per) fluoropolyether polymer. The invented article shows excellent performance on amphiphobicity and transparency.

The present invention relates to an article comprising a substrate at least partially coated with a composition comprising solid in the form of aggregate and (per)fluoropolyether polymer.

### PRIOR ART

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of common general knowledge in the field.

Anti-soiling coating has drawn great research interest in the past few years due to its wide applications in different areas, such as PV industry, transportation, architecture, optics, electronics and aerospace.

One passive way to achieve soil preventive function is to generate thin hydrophobic and/or oleophobic films on top of the substrate surface. Various processes for forming the hydrophobic and/or oleophobic film by forming roughness on the surface of a base material such as glass or a resin and then coating fluoropolymer functional layer on the bottom layer have been known.

US 2006/0154048 discloses an article coated with a functional coating film which comprises a primer layer comprising silicon oxide as the main component and a functional coating layer coating the primer layer. The article mentioned above exhibits simultaneously excellent water repellent property or the excellent antifouling property and transparency is maintained. However, oleophobic function hasn't been specifically considered in this patent.

Palanikkumaran Muthiah et al. Journal of Colloid and Interface Science 409(2013) 227-236 teaches dual-layered-coated mechanically-durable superomniphoic surfaces with anti-smudge properties. Nevertheless, the concentration of fluoropolymers used is very high, which leads to high production cost and operational difficulty.

A hydrophobic and oleophobic silicon dioxide based transparent coating film is disclosed by CN103951279A. It indicates pore-forming agent is necessary in this mothed to obtain desired film thickness, the proportion of large and small-sized structures, space filling factors.

Further, numerous teachings of the prior arts relate to similar coatings without consideration of hydrophobic and/or oleophobic function. For instance, US 2009/0075092 discloses a low-index silica coating by depositing the silica precursor on a glass substrate to form a coating layer first and then a surface treatment composition is deposited on the coating layer. The organic material that preferably used in surface treatment composition could be fluorinated polyether materials such as Fluorolink S10, Fluorolink F10, Fluorolink F10A, Fluorolink P56. However, this application aims at producing antireflective coatings. Silica containing layer is comprised of a silane and/or a colloidal silica and treated by curing and/or firing at a temperature between 550-700° C. to obtain a porous coating. Specifically, particles of colloidal silica used in this invention are normally spherical in shape. Upon high temperature, the colloidal silica particles keep their shape. A smooth and complete layer is formed like a “glass”, which holds the particles together and stick them to the substrate.

Nevertheless, abovementioned coating film are not ideal, since they have disadvantages like poor amphiphobicity, inevitably using pore-forming agent or high concentrated fluoropolymer, which lead to high cost for commercialization production or difficulty in operation.

### INVENTION

There is thus a significant need in the art for providing an improved an anti-soiling coating film with desired characteristics, notably optimized hydrophobicity and oleophobicity, lower production cost, ease of handling and without loss of transparency.

Thus, the present invention relates to an article comprising a substrate at least partially coated with a composition comprising:

(i) Solid particle A,
(ii) Solid particle B,
(iii) At least one (per)fluoropolyether polymer,
wherein solid particle A is in the form of aggregate and solid particle A or solid particle B comprises at least one metal element chosen in a group consisting of Group IA, IIA, IIIA, IVA, VA, VIA, VIIA, IB, IIB, IIIB, IVB, VB, VIB, VIIB, VIIIB, lanthanide or actinide elements of the Periodic Table and any combination thereof.

This invention also concerns a process for producing invented article.

Other characteristics, details and advantages of the invention will emerge even more fully upon reading the description which follows.

### Definitions

Throughout the description, including the claims, the term “comprising one” should be understood as being synonymous with the term “comprising at least one”, unless otherwise specified, and “between” should be understood as being inclusive of the limits.

As used herein, the term “transition metals” refer to the metals of group IB, IIB, IIIB, IVB, VB, VIB, VIIB and VIIIB.

As used herein, the term “post-transition metals” refer to the metallic elements in the periodic table located between the transition metals (to their left) and the metalloids (to their right). Usually included in this category are gallium, indium and thallium; tin and lead; and bismuth.

As used herein, the term “rare earth element (REE)” or “rare earth metal” is one of a set of seventeen chemical elements in the periodic table, meaning the fifteen lanthanides plus scandium and yttrium.

As used herein, amphiphobic surfaces means hydrophobic (that show repellency against water) and oleophobic (that show repellency against oils, for example, hexadecane) surfaces.

As used herein, the acronym “PFPE” stands for “(per)fluoropolyether” and, when used as substantive, is intended to mean either the singular or the plural from, depending on the context and the term “(per)fluoropolyether” is intended to indicate fully or partially fluorinated polymer having a molecular structure that can be branched, linear, or a combination thereof.

As used herein, “aggregate” means an assembly of primary particles that have grown together and are aligned side by side. The total specific surface area is less than the sum of the surface areas of the primary particles.

As used herein, “agglomerate” are an assembly formed by physical interactions of primary particles (e g joined together at the corners or edges), and/or aggregates whose total surface area does not differ appreciable from the sum of specific surface areas of primary particles.

As used herein, “Alkyl” means a straight chain or branched saturated aliphatic hydrocarbon. Preferably alkyl group comprises 1-18 carbon atoms. Representative saturated straight chain alkyls include methyl, ethyl, n-propyl, n-butyl, n-pentyl, and the like; while saturated branched alkyls include isopropyl, sec-butyl, isobutyl, tert-butyl, isopentyl, and the like.

As used herein, “Aryl” means a 6-carbons monocyclic or 10-carbons bicyclic aromatic ring system wherein 0, 1, 2, 3, or 4 atoms of each ring are substituted. Examples of aryl groups include phenyl, naphthyl and the like. The term “arylalkyl” or the term “aralkyl” refers to alkyl substituted with an aryl. The term “arylalkoxy” refers to an alkoxy substituted with aryl.

As used herein, the terminology “(Cₙ-Cₘ)” in reference to an organic group, wherein n and in are each integers, indicates that the group may contain from n carbon atoms to in carbon atoms per group.

Should the disclosure of any patents, patent applications, and publications which are incorporated herein by reference conflict with the description of the present application to the extent that it may render a term unclear, the present description shall take precedence.

### BRIEF DESCRIPTION OF DRAWINGS

FIG. 1 and FIG. 2 are SEM (Scanning Electron Microscopy) images in different scales of functional coating film obtained by example 6.

FIG. 3 is AFM (Atomic Force Microscopy) DMT Modulus image of functional coating film obtained by example 6.

FIG. 4 is AFM (Atomic Force Microscopy) 3D image of functional coating film obtained by example 6.

### DETAILS OF THE INVENTION

The present invention relates to an article comprising a substrate at least partially coated with a composition comprising:

(i) Solid particle A,
(ii) Solid particle B,
(iii) At least one (per)fluoropolyether polymer,
wherein solid particle A is in the form of aggregate and solid particle A or solid particle B comprises at least one metal element chosen in a group consisting of Group IA, IIA, IIIA, IVA, VA, VIA, VIIA, IB, IIB, IIIB, IVB, VB, VIB, VIIIB, lanthanide or actinide elements of the Periodic Table and any combination thereof.

It should be understood the composition mentioned above forms a functional coating film on the substrate. Without wishing to be bound to any particular theory, when the functional coating film is applied to a substrate above mentioned, it shows good performance on amphiphobicity and transparency.

In present invention, hydrogen is not included in metal element chosen in Group IA of the Periodic Table. Carbon is not included in metal element chosen in Group IVA of the Periodic Table. Nitrogen and phosphorus are not included in metal element chosen in Group VA of the Periodic Table. Oxygen, sulfur and selenium are not included in metal element chosen in Group VIA of the Periodic Table. Fluorine, chlorine, bromine and iodine are not included in metal element chosen in Group VIIA.

In present invention, the metal elements for the purpose of the present invention are also referred to as metalloids. The term metalloid is generally designating an element which has properties between those of metals and non-metals. Typically, metalloids have a metallic appearance but are relatively brittle and have a moderate electrical conductivity. The six commonly recognized metalloids are boron, silicon, germanium, arsenic, antimony, and tellurium. Other elements also recognized as metalloids include aluminum, polonium, and astatine. On a standard periodic table all of these elements may be found in a diagonal region of the p-block, extending from boron at one end, to astatine at the other (as indicated above).

It should be understood that form of metal element in solid particle A or solid particle B in is not particularly limited. Preferably, metal element in solid particle A or solid particle B might be in elemental form, metal alloy or metal compound and more preferably metal compound.

In present invention, solid particle A or solid particle B comprising at least one metal element can be of the same chemical nature. For example, solid particle A or solid particle B can consist of the same metal in elemental form, of the same metal alloy, of the same metal compound. Alternatively, solid particle A or solid particle B can be of different chemical nature. For example, solid particle A or solid particle B can consist of two kinds of different metal oxide.

In one embodiment of present invention, solid particle A or solid particle B comprises at least one metal element in elemental form. For example, solid particle A or solid particle B comprises one and only one metal element in elemental form. Also for example, solid particle A or solid particle B comprises a metal alloy comprising at least two metal elements in elemental form.

A metal alloy can be viewed as a solid metal-solid metal mixture wherein a primary metal acts as solvent while other metal(s) act(s) as solute; in a metal alloy and wherein the concentration of the metal solute does not exceed the limit of solubility of the metal solvent.

Metal compound of present invention may be chosen in a group consisting of: metal oxide compounds, metal sulphide compounds and metal selenide compounds. Preferably, the metal compound is a metal oxide.

Metal oxide compounds comprise typically at least one oxygen atom and at least one metal atom which is chemically bound to the oxygen atom. The metal atom comprised in the metal oxide can be notably transition metal element, post transition metal element, rare earth metal element or metalloid element.

Examples of metal oxide compounds notably are:
Transition metal oxides, such as: titanium oxide (TiO₂), zinc oxide (ZnO) and zirconium oxide (ZrO₂).
Post transition metal oxides, such as: aluminum oxide (Al₂O₃).
Rare earth element oxides, such as: cerium oxide (CeO₂), lanthanium oxide (La₂O₃), praseodymium oxide (Pr₆O₁₁), neodymium oxide (Nd₂O₃) and yttrium oxide (Y₂O₃).
Metalloid element oxides, such as: boron oxide (B₂O₃) and silicon oxide (SiO₂).

The metal oxide compound of solid particle A or solid particle B of present invention may be a single oxide or a mixed oxide.

Preferred mixed oxides of the present invention are chosen in the group consisting of: SiO₂—CeO₂, SiO₂—TiO₂, SiO₂—La₂O₃, SiO₂—ZrO₂, SiO₂—Pr₂O₃ and CeO₂—ZrO₂—La₂O₃.

Solid particle A, which is in the form of aggregate might be irregular and formed by one dimensional to three dimensional bonding of the particles. Said aggregates could create a layer having a structure with specific uneven height of roughness.

Solid particle B of present invention is in the form other than aggregate. The form is not particularly limited. For example, solid particle B could be in the form of primary particle or agglomerate.

In present invention, the average particle diameter of solid particle B is comprised between 10 nm and 1 μm, preferably between 30 nm and 500 nm and more between preferably 50 nm and 150 nm.

The term average particle diameter of solid particle B when used herein refers to the D₅₀ median diameter computed on the basis of the intensity weighed particle size distribution as obtained by the so called Contin data inversion algorithm. Generally said, the D₅₀ divides the intensity weighed size distribution into two equal parts, one with sizes (diameters) smaller than D₅₀ and one with sizes (diameters) larger than D₅₀.

The ratio of particle size of solid particle A to solid particle B may be of at least 3:1 and preferably of at least 5:1. In one embodiment, the ratio of particle size of solid particle A to solid particle B may be comprised between 3:1 and 100:1 and more preferably between comprised between 5:1 and 15:1. In another embodiment, the average particle diameter of solid particle A is comprised between 30 nm and 5 μm, preferably between 50 nm and 1 μm and more between preferably 90 nm and 500 nm.

The term average particle diameter of solid particle B could be determined by image analysis on SEM micrographs.

The weight ratio of solid particle A may be comprised between 1% and 90% based on total weight of the composition of functional coating film, preferably comprised between 20 wt % and 80 wt % and more preferably between comprised between 30 wt % and 70 wt %.

The weight ratio of solid particle B may be comprised between 1% and 90% based on total weight of the composition of functional coating film, preferably comprised between 20 wt % and 80 wt % and more preferably between comprised between 30 wt % and 70 wt %.

According to a preferred embodiment, said (per)fluoropolyether (PFPE) polymer comprises recurring units derived from:

(a) At least one diol of poly-ether or poly-ester type, or polybutadien-diol;
(b) At least one hydroxy-terminated (per)fluoropolyether polymer;
(c) At least one aromatic, aliphatic or cycloaliphatic diisocyanate; and
(d) At least one aliphatic, cycloaliphatic or aromatic diol having from 1 to 14 carbon atoms.

According to another preferred embodiment, said (per)fluoropolyether polymer comprises:
at least one (per)fluoropolyether chain [chain (R_{pf})] and
two chains [chains (Rₑ)] linked to opposite sides of said (R_{pf}), wherein at least one each chain (Rₑ) comprises a functional group [group G] selected in the group comprising: hydroxy group, acid group and derivatives thereof, silane-containing group, mono- and bi-cyclic aromatic and aliphatic rings optionally substituted with alkyl group comprising 1 to 3 carbon atoms, amino group optionally substituted with alkyl group comprising 1 to 3 carbon atoms, alkyl-amide group, unsaturated moieties, alkyl chain comprising from 1 to 10 carbon atoms optionally substituted with 1 to 4 hydroxy groups.

Preferably, said chains (Rₑ) are linked to said chain (R_{pf}) via a sigma bond or a (poly)oxyalkylene chain [chain (Rₐ)] comprising from 1 to 50 fluorine-free units of formula —CH₂CH(J)O—, wherein J is independently selected from hydrogen atom, straight or branched alkyl or aryl, preferably hydrogen atom, methyl, ethyl or phenyl.

Preferably, both chains (Rₑ) comprise one group G as defined above. When only one chain (Rₑ) comprises a group G as defined above, the other chain (Rₑ) comprises a neutral group selected from H, F, Cl and (per)fluorinated alkyl chain comprising from 1 to 6 carbon atoms. More preferably, said (per)fluorinated alkyl chain is selected from —CF₃, —C₂F₅, —C₃F₇, —CF₂Cl, —CF₂CF₂Cl and —C₃F₆Cl.

Preferably, said chain (R_{pf}) is a chain of formula:

—O-D-(CFX^{#})_{z1}—O(R_{f})(CFX*)_{z2}-D*-O—

wherein
z1 and z2, equal or different from each other, are equal to or higher than 1;
X^{#} and X*, equal or different from each other, are —F or —CF₃, provided that when
z1 and/or z2 are higher than 1, X^{#} and X* are —F;
D and D*, equal or different from each other, are an alkylene chain comprising from 1 to 6 and even more preferably from 1 to 3 carbon atoms, said alkyl chain being optionally substituted with at least one perfluoroalkyl group comprising from 1 to 3 carbon atoms;
(R_{f}) comprises, preferably consists of, repeating units R^{o}, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, H;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T,
wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently F or CF₃ and T being a C₁-C₃ perfluoroalkyl group.

Preferably, z1 and z2, equal or different from each other, are from 1 to 10, more preferably from 1 to 6 and even more preferably from 1 to 3.

Preferably, chain (R_{f}) complies with the following formula:

(R_{f}-I)-[(CFX¹O)_{g1}(CFX²CFX³O)_{g2}(CF₂CF₂CF₂O)_{g3}(CF₂CF₂CF₂CF₂O)_{g4}]—

wherein
X¹ is independently selected from —F and —CF₃,
X², X³, equal or different from each other and at each occurrence, are independently —F, —CF₃, with the proviso that at least one of X is —F;
g1, g2, g3, and g4, equal or different from each other, are independently integers ≥0, such that g1+g2+g3+g4 is in the range from 2 to 300, preferably from 2 to 100; should at least two of g1, g2, g3 and g4 be different from zero, the different recurring units are generally statistically distributed along the chain.

More preferably, chain (R_{f}) is selected from chains of formula:

(R_{f}-IIA)-[(CF₂CF₂O)ₐ₁(CF₂O)ₐ₂]—

wherein:
a1 and a2 are independently integers ≥0 such that the number average molecular weight is between 400 and 10,000, preferably between 400 and 5,000; both a1 and a2 are preferably different from zero, with the ratio a1/a2 being preferably comprised between 0.1 and 10;

(R_{f}-IIB)-[(CF₂CF₂O)_{b1}(CF₂O)_{b2}(CF(CF₃)O)_{b3}(CF₂CF(CF₃)O)_{b4}]—

wherein:
b1, b2, b3, b4, are independently integers ≥0 such that the number average molecular weight is between 400 and 10,000, preferably between 400 and 5,000; preferably b1 is 0, b2, b3, b4 are ≥0, with the ratio b4/(b2+b3) being ≥1;

(R_{f}-IIC)-[(CF₂CF₂O)_{c1}(CF₂O)_{c2}(CF₂(CF₂)_{cw}CF₂O)_{c3}]—

wherein:
cw=1 or 2;
c1, c2, and c3 are independently integers ≥0 chosen so that the number average molecular weight is between 400 and 10,000, preferably between 400 and 5,000;
preferably c1, c2 and c3 are all >0, with the ratio c3/(c1+c2) being generally lower than 0.2;

(R_{f}—IID)-[(CF₂CF(CF₃)O)_{d}]—

wherein:
d is an integer >0 such that the number average molecular weight is between 400 and 10,000, preferably between 400 and 5,000;

Still more preferably, chain (R_{f}) complies with formula (R_{f}—III) here below:

(R_{f}-III)-[(CF₂CF₂O)ₐ₁(CF₂O)ₐ₂]—

wherein:
a1, and a2 are integers >0 such that the number average molecular weight is between 400 and 10,000, preferably between 400 and 5,000, with the ratio a1/a2 being generally comprised between 0.1 and 10, more preferably between 0.2 and 5.

Preferably, said [group G] is selected in the group comprising: hydroxy group, acid group and derivatives thereof, silane-containing group and alkyl chain comprising from 1 to 10 carbon atoms optionally substituted with 1 to 4 hydroxy groups.

More preferably, said acid group is selected from carboxy group, phosphate group and derivatives thereof such as esters and salts, preferably ammonium salt thereof. Even more preferably, said carboxy group is a phosphate group.

More preferably, said silane-containing group is selected from alkoxy silane groups. Even more preferably, the alkoxy silane group is a group of formula —Si(R¹)(R²)(R³) wherein R¹, R² and R³ are each independently H or an alkoxy group having from 1 to 6 carbon atoms, more preferably 1 carbon atom, provided that at least one of R¹, R² and R³ is different from H.

Preferred examples of (per)fluoropolyether polymer comprise:
one (per)fluoropolyether chain [chain (R_{pf})] and
two chain ends [chains (Rₑ)], each chain (Rₑ) comprising a group selected from silane-containing group, acid group and derivatives thereof;
wherein said chains (Rₑ) are linked to opposite sides of said (R_{pf}) via a sigma bond.

(Per)fluoropolyether polymer are commercially available for example from Solvay Specialty Polymers Italy S.p.A., under the trade names Fomblin® and Fluorolink®, such as notably Fluorolink® F10 and Fluorolink® S10. Polymers comprising chain (Ra) can be prepared as disclosed in WO 2014/090649.

The weight ratio of (per)fluoropolyether polymer may be comprised between 1% and 30% based on total weight of the composition of functional coating film and preferably between 5 wt % and 20 wt %.

The coating composition film of the present invention may also include a hydrophobic additive, which can increase the water repellency of a coating.

The substrate used in the present invention is not particularly limited. Base materials having hydrophilic group on the surface are more preferable. It is preferable that one of transparent glass plate, resin plate and resin film is used. Among these, transparent glass plate is more preferable.

In one embodiment, the mean roughness (Ra) of the functional coating film of present invention is comprised between 5 nm and 250 nm, preferably between 15 nm and 70 nm and more preferably between 30 nm and 60 nm. Z-Range is preferably comprised between 200 nm and 750 nm and more preferably between 300 nm and 600 nm. As used herein, the “mean roughness (Ra)” is the arithmetic average of the absolute values of the roughness profile ordinates. “Z-Range” is average distance between the highest peak and lowest valley in each sampling length. Measure of roughness could be performed on a Dimension Icon microscope from Bucker.

In another embodiment, the root mean roughness (Rq) of the functional coating film of present invention is comprised between 5 nm and 250 nm, preferably between 20 nm and 85 nm and more preferably between 40 nm and 70 nm. Z-Range is preferably comprised between 200 nm and 750 nm and more preferably between 300 nm and 600 nm. As used herein, the “root mean square (RMS) roughness (Rq)” is the root mean square average of the roughness profile ordinates.

In one embodiment, the functional coating has a water contact angle comprised between 130°-180° and oil contact angle comprised between 90°-150°. Measurement of contact angle is performed on an optical tensiometer, such as Theta Attension, Biolin Scientific, Finland and obtained by capturing an image of the droplet deposited on the articles. The contact angles are analyzed using Owens-Wendt-Rabel and Kaelble method to calculate surface energy.

The present invention is also direct to a coating process for producing an article above mentioned, comprising steps of:
(i) Contacting at least an area of the surface of the substrate with a composition (b) comprising solid particle B source, optionally in admixture with a PFPE polymer,
(ii) Drying and optionally curing the layer obtained in step (i),
(iii) Contacting the layer obtained in step (ii) with a composition (a) comprising solid particle A source, optionally in admixture with a PFPE polymer,
(iv) Drying and optionally curing the layer obtained in step (iii),
(v) Optionally contacting the surface the article obtained in step (iv) with a composition (c) comprising at least one PFPE polymer,
(vi) Optionally drying and/or curing the layer obtained in step (v);

provided that composition (a) comprises a PFPE polymer when step (v) and (vi) are not comprised.

The invention as so concerns an article susceptible to be obtained by the process as mentioned above.

It should be understood by the people skilled in the art that solid particle A source or solid particle B source of present invention might be in same or different form with solid particle A or solid particle B in invented article. The form of solid particle A source or solid particle B source is not particularly limited and it could be in any form as long as it can realize the invented article. For example, solid particle A source in composition (a) might be in the form of primary particle. It might be transferred into aggregate after coating process.

In one embodiment, solid particle A source or solid particle B source may have the same chemical components as solid particle A or solid particle B in functional coating film. For example, solid particle A source and solid particle A in functional coating film can consist of same metal oxide.

In another embodiment, solid particle A source or solid particle B source may have different chemical components as solid particle A or solid particle B in functional coating film. For example, solid particle A source, which comprises a metal compound can be finally transferred to solid particle A which comprises a metal oxide in functional coating film after coating process.

Preferably, solid particle A source or solid particle B source may be chosen in a group consisting of transition metal oxides, post transition metal oxides, rare earth element oxides, metalloid element oxides or combinations thereof. More preferably, solid particle A source or solid particle B source may be chosen in a group consisting of cerium oxide, titanium oxide, aluminum oxide and zinc oxide, silicon oxide or any combination thereof. Most preferable solid particle A source may be precipitated silica. Examples of precipitated silica are commercially available from Solvay Tixosil® 365, Zeosil® 1085GR. Preferable solid particle B source may be colloidal silica. Example of colloidal silica could be obtained from its precursor tetraethyl orthosilicate (TEOS), which is commercially available from Sinopharm Chemical Reagent Co., Ltd.

In present invention, the average particle diameter of solid particle B source is comprised between 10 nm and 1 μm, preferably between 30 nm and 500 nm and more between preferably 50 nm and 150 nm.

In present invention, the average particle diameter of solid particle A source is comprised between 30 nm and 4 μm and preferably between 50 nm and 150 nm.

In the present invention, the composition (a), composition (b) and composition (c) may be in the form of fluid. In one embodiment, solid particle A source, solid particle B source or PFPE polymer is dispersed or dissolved in a solvent to form the fluids before coating. The solvents in fluids are not particularly limited as long as components, such as solid particle A source, solid particle B source or PFPE polymer could be sufficiently dispersed or dissolved.

The solvent for dissolving or dispersing solid particle A source or solid particle B source might be chosen in a group consisting of water, alcohols, ether, ester, ketone and any combination thereof.

Typical solutions or dispersions for the PFPE polymers are prepared using solvents have boiling points high enough to avoid bubble formation during the drying and/or curing process. The solvent for dissolving or dispersing PFPE polymer might be selected in the group consisting of water, alkane, alkene, arene, halogenated-hydrocarbon, ether, ester, ketone, alcohol, carboxylic acid, or a combination thereof. Exemplary solvents include ethanol, isopropanol, methanol, acetone, tetrahydrofuran, propylene glycol monomethyl ether, propylene glycol methyl ether acetate, dipropylene glycol monomethyl ether and any combination thereof.

The concentration of solid particle A source in composition (a) is comprised between 0.1% and 2.0% by weight ratio when it is dispersed or dissolved in a fluid and preferably between 0.3% and 1.2% by weight ratio.

The concentration of solid particle B source in composition (b) is comprised between 0.1% and 10.0% by weight ratio when it is dispersed or dissolved in a fluid and preferably between 0.5% and 5.0% by weight ratio.

The PFPE polymer concentration in fluid may be adjusted to achieve a workable viscosity of the solution and will vary with the particular polymer, the other components of the functional film and the process equipment and conditions used.

The concentration of PFPE polymer in fluid may be preferably comprised between 0.01% and 20.00% by weight ratio and preferably between 0.10% and 15.00% by weight ratio.

In one embodiment, the concentration of Fluorolink® S10 in fluid may be preferably comprised between 0.10% and 0.40% by weight ratio and preferably between 0.15% and 0.25% by weight ratio.

In another embodiment, the concentration of Fluorolink® F10 in fluid may be preferably comprised between 5.0% and 15.0% by weight ratio and preferably between 8.0% and 12.0% by weight ratio.

It should be understood by the people skilled in the art that for every coating layer, it is preferable to have a drying process to remove the solvent after every kind of fluid is applied. Solvent can be removed by any means known in the art, such as being evaporated at proper temperature.

The PFPE polymer containing coating layers of present invention need to be cured to form a crosslinked coating and adhere to the surface of base material or another coating layer. The cure parameters might vary depending on the polymer, hydrophobic additive and other components and can be readily determined by one skilled in the art. Curing can be performed for example by heating or via a photochemical route, for example by UV curing.

In present invention, curing could be performed by heating. In this case, the curing temperature is preferably comprised between 100° C. and 200° C., more preferable between 100° C. and 160° C. and most preferably between 120° C. and 150° C. Curing time for curing is comprised between 5 min and 48 hours, more preferable between 15 min and 2 hours and most preferably between 25 min and 1 hour.

When a PFPE polymer containing coating layer is formed, drying process and curing process could be alternatively achieved by a single heating or by multiple heating.

In one preferred embodiment of present invention, the coating process for producing an invented article, comprising steps of:
(i) Contacting an area of a surface of substrate with a composition comprising colloidal silica,
(ii) Drying the layer obtained in step (i),
(iii) Contacting layer obtained in step (ii) with a composition comprising precipitated silica,
(iv) Drying the layer obtained in step (iii),
(v) Contacting layer obtained in step (iv) with a composition comprising at least one PFPE polymer,
(vi) Drying and curing the layer obtained in step (v).

In another preferred embodiment of present invention, the coating process for producing an invented article, comprising steps of:
(i) Contacting an area of a surface of substrate with a composition comprising colloidal silica,
(ii) Drying the layer obtained in step (i),
(iii) Contacting layer obtained in step (ii) with a composition comprising precipitated silica in admixture with a PFPE polymer,
(iv) Drying and curing the layer obtained in step (iii).

In another preferred embodiment of present invention, the coating process for producing an invented article, comprising steps of:
(i) Contacting an area of a surface of substrate with a composition comprising colloidal silica in admixture with a PFPE polymer,
(ii) Drying the curing the layer obtained in step (i),
(iii) Contacting layer obtained in step (ii) with a composition comprising precipitated silica in admixture with a PFPE polymer,
(iv) Drying and curing the layer obtained in step (iii).

Alternatively, UV-ozone treatment, which activates surface of substrate by using ozone formed by ultraviolet irradiation is performed to the surface of the before functional film is coated, i.e. before each of steps (i) as defined above is performed.

In the present invention, functional coating film may be deposited in any suitable manner, for example, spin-coating, roll-coating, spray-coating, dip-coating, bar coating, flow-coating and any other method of depositing the coating on a substrate. Among these, spray-coating, bar-coating are more preferable.

### EXPERIMENTAL PART

### Example 1: Glass Substrate Pre-Treatment

Glass substrates (VWR® Micro Cover Glasses, Ref No 48366-249) were cleaned by means of sonication (ethanol, 15 min) followed by activation in an UV-ozone photo reactor (Sea Biscuit Trade, 40 min).

### Example 2: Silica Colloidal Solution Preparation

A mixture of 42 ml of ethanol (AR, Sinopharm Chemical Reagent Co., Ltd), 15 ml of ammonium solution (0.4 N), and 3.1 ml of TEOS (molecular formula Si(OC₂H₅)₄, AR, Sinopharm Chemical Reagent Co., Ltd) was mixed well in a sealed glass flask in an ultrasonic bath (10 min) Ammonia solution was used to adjust the pH value of the Si-containing sol in order to control the size of silica nanoparticles, and subsequently the mixture was magnetically stirred at room temperature for 0.5 h. Particle size distribution (PSD) of silica nanospheres was around 100 nm and pH of TEOS solution is 11. The concentration of colloidal silica solution is 5.0 wt %.

### Example 3: Tixosil 365 Aqueous Suspension Preparation

Tixosil 365 is a commercial product of Solvay (http://www.solvay.com/en/markets-and-products/featured-products/tixosil.html). 0.1 g of Tixosil 365 was diluted in 9.9 g of deionized water with the help of Ultrasonic cell disruptor (2-time dispersion needed) obtain a 1.0 wt % solution.

### Example 4: Fluorolink® S10 Formulation Pre-Treatment

0.08 g H₂O, 0.02 g acetic acid and 0.02 g Fluorolink® S10 were added to 9.88 g isopropanol (IPA) to obtain a 0.2 wt % Fluorolink® S10 solution. The standing time was 30 minutes.

### Example 5: Functional Coating Film Preparation (TEOS+(T365+S10))

The surface of glass substrates was modified by spin-coating (spin processor POLOS™, SPS Europe) by 4-time diluted TEOS solution of Example 2 for 60 s at 1 000 rpm (1 cycle). It was then dried under atmosphere.

Mix the Tixosil 365 aqueous suspension of Example 3 and S10 formulation of Example 4 (50/50, v/v). The mixture was then coated upon the silica nanosphere layer by spin-coating: 60 s at 1 000 rpm (3 cycles). It formed the perfluorinated silica aggregates layer.

The final coating was dried at 100° C. for 15 min and then cured at 150° C. for 60 min. The treated sample was rinsed by isopropanol to remove S10 excess after cooling down to room temperature and then dried under atmosphere.

The roughness of functional coating film is 41 nm (Ra), 57 nm (Rq) and 505 nm (Z-range).

### Example 6: Functional Coating Film Preparation (TEOS+S10)+(T365+S10)

All the TEOS solution of Example 2 was diluted for 4 times with ethanol. 0.02 g pure Fluorolink® S10 was added into the 9.98 g diluted solution and then mixed by magnetic agitation for 4 h. The mixed solution should stand for 8 h prior to use. The mixture was coated on the activated glass surface by spin-coating to create primer layer: 60 s at 1 000 rpm (1 cycle) and then dried at 70° C. for 15 min and cured at 150° C. for 60 min.

Mix the Tixosil 365 aqueous suspension of Example 3 and S10 formulation of Example 4 (50/50, v/v). The mixture was then coated upon the silica nanosphere layer by spin-coating: 60 s at 1 000 rpm (3 cycles). It formed the perfluorinated silica aggregates layer and was dried under atmosphere.

The final coating was dried at 100° C. for 15 min and then cured at 150° C. for 60 min. The treated sample was rinsed by isopropanol to remove S10 excess after cooling down to room temperature and dried under atmosphere.

The roughness of functional coating film is 38 nm (Ra), 52 nm (Rq) and 422 nm (Z-range).

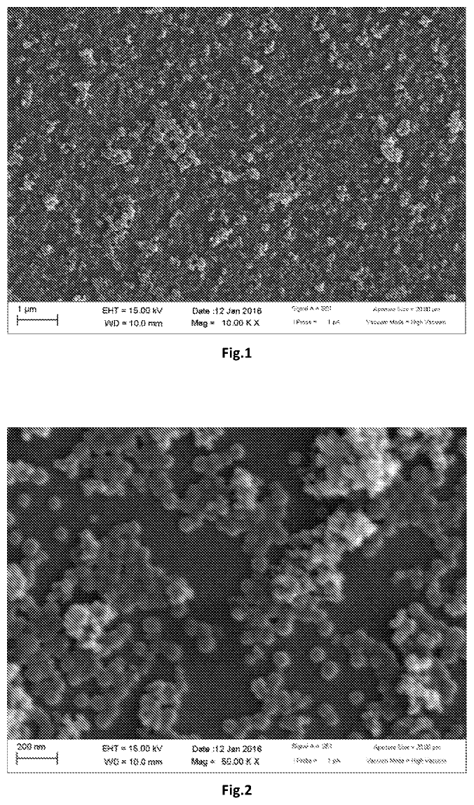

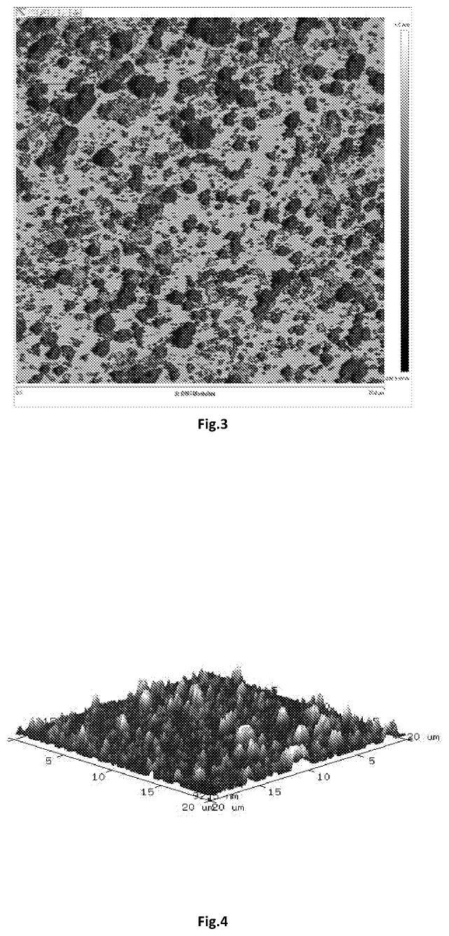

Further observation of SEM images (FIGS. 1-2) and AFM images (FIGS. 3-4) of the final product made it clear that the glass substrate is partially covered with clusters of rather spherical particles, which is derived from TEOS (bottom layer). Aggregated particles derived from Tixosil 365 are on the top of bottom layer. Thanks to the specific roughness formed by those particles on the substrate, the amphiphobicity performance is excellent.

### Comparative Example 1

TABLE 1
Performance of glass, glass coated with Fluorolink ®
S10 and functional film obtained from Example 5 and 6

| | Water contact | Oil contact | Transmittance(%) |
|---|---|---|---|
| EX | angle(°) | angle(°) | at 350 nm |
| Glass only (*) | 54 | 45 | 92 |
| S10 (*) | 111 | 78 | 90 |
| TEOS + | 169 | 107 | 86 |
| (T365 + S10) | | | |
| (TEOS + S10) + | 172 | 139 | 80 |
| (T365 + S10) | | | |

(*) comparative example
Glass coated with Fluorolink ® S10 is obtained by following steps: Apply the 0.2 wt % Fluorolink ® S10 solution of Example 4 by dip coating, which lasted for 2 hours.

The final coating was dried at 100° C. for 15 min and then cured at 150° C. for 60 min. The treated sample was rinsed by isopropanol to remove S10 excess after cooling down to room temperature and then dried under atmosphere.

The water contact angles and oil (sunflower oil) contact angles were measured on Theta Attension. The transmittance measurements were done by hardware AvaSpec-ULS3648-4-USB2 and AvaLight-DH—S-BAL using Avasoft 7.6.

It appears article of the present invention show excellent performance on hydrophobicity, oleophobicity and transparency.

1. An article comprising a substrate at least partially coated with a composition comprising:
(i) Solid particle A,
(ii) Solid particle B,
(iii) At least one (per)fluoropolyether polymer,
wherein solid particle A is in the form of aggregate and solid particle A or solid particle B comprises at least one metal element selected from the group consisting of Group IA, IIA, IIIA, IVA, VA, VIA, VIIA, IB, IIB, IIIB, IVB, VB, VIB, VIIIB, lanthanide and actinide elements of the Periodic Table and any combination thereof.

2. The article according to claim 1, wherein solid particle A or solid particle B is selected from the group consisting of transition metal oxides, post transition metal oxides, rare earth element oxides, metalloid element oxides and any combination thereof.

3. The article according to claim 2, wherein solid particle A or solid particle B is selected from the group consisting of cerium oxide, titanium oxide, aluminum oxide, zinc oxide, silicon oxide and any combination thereof.

4. The article according to claim 2, wherein solid particle A or solid particle B is silicon oxide.

5. The article according to claim 1, wherein the average particle diameter of solid particle B is comprised between 10 nm and 1 μm.

6. The article according to claim 1, wherein the ratio of particle size of solid particle A to solid particle B is at least 3:1.

7. The article according to claim 1, wherein the weight ratio of solid particle A is comprised between 20% and 80% based on total weight of the composition of functional coating film.

8. The article according to claim 1, wherein the weight ratio of solid particle B is comprised between 20% and 80% based on total weight of the composition of functional coating film.

9. The article according to claim 1, wherein the (per)fluoropolyether polymer comprises recurring units derived from:
(i) At least one diol of poly-ether or poly-ester type, or polybutadien-diol;
(ii) At least one hydroxy-terminated (per)fluoropolyether polymer;
(iii) At least one aromatic, aliphatic or cycloaliphatic diisocyanate; and
(iv) At least one aliphatic, cycloaliphatic or aromatic diol having from 1 to 14 carbon atoms.

10. The article according to claim 1, wherein (per)fluoropolyether polymer comprises:
(i) at least one (per)fluoropolyether chain [chain (R_{pf})] and
(ii) two chains [chains (Rₑ)] linked to opposite sides of said (R_{pf}), wherein at least one each chain (Rₑ) comprises a functional group [group G] selected in the group comprising: hydroxy group, acid group and derivatives thereof, silane-containing group, mono- and bi-cyclic aromatic and aliphatic rings optionally substituted with alkyl group comprising 1 to 3 carbon atoms, amino group optionally substituted with alkyl group comprising 1 to 3 carbon atoms, alkyl-amide group, unsaturated moieties, alkyl chain comprising from 1 to 10 carbon atoms optionally substituted with 1 to 4 hydroxy groups.

11. The article according to claim 10, wherein (R_{pf}) is a chain of formula:
—O-D-(CFX^{#})_{z1}—O(R_{f})(CFX*)_{z2}-D*-O—
wherein
z1 and z2, equal or different from each other, are each equal to or higher than 1;
X^{#} and X*, equal or different from each other, are each —F or —CF3, provided that when z1 and/or z2 are higher than 1, X^{#} and X* are each —F;
D and D*, equal or different from each other, are each an alkylene chain comprising from 1 to 6 carbon atoms, said alkylene chain being optionally substituted with at least one perfluoroalkyl group comprising from 1 to 3 carbon atoms;
(R_{f}) comprises repeating units R^{o}, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, or H;
(iv) —CF₂CF₂CF₂CF₂O—;
(v) —(CF₂)ⱼ—CFZ—O—, wherein j is an integer from 0 to 3 and Z is a group of general formula —O—R_{(f-a)}-T,
wherein R_{(f-a)} is a fluoropolyoxyalkene chain comprising a number of repeating units from 0 to 10, said repeating units being selected from the group consisting of: —CFXO—, —CF₂CFXO—, —CF₂CF₂CF₂O—, and —CF₂CF₂CF₂CF₂O—, with each of X being independently F or CF₃ and T being a C₁-C₃ perfluoroalkyl group.

12. The article according to claim 11, wherein said chain (R_{f}) is a chain of formula —[(CFX¹O)_{g1}(CFX²CFX³O)_{g2}(CF₂CF₂CF₂O)_{g3}(CF₂CF₂CF₂CF₂O)_{g4}]—
Wherein:
X¹ is independently selected from the group consisting of —F and —CF₃,
X² and X³, equal or different from each other and at each occurrence, are each independently —F, or —CF₃, with the proviso that at least one of X¹, X², and X³ is —F;
g1, g2, g3, and g4, equal or different from each other, are each independently an integer ≥0, such that g1+g2+g3+g4 is in the range from 2 to 300; should at least two of g1, g2, g3 and g4 be different from zero, the different repeating units are generally statistically distributed along the chain.

13. The article according to claim 10, wherein group G is selected in the group consisting of: hydroxy group, acid group and derivatives thereof, silane-containing group and alkyl chain comprising from 1 to 10 carbon atoms optionally substituted with 1 to 4 hydroxy groups.

14. The article according to claim 10, wherein said (per)fluoropolyether polymer comprises:
one (per)fluoropolyether chain [chain (R_{pf})] and
two chain ends [chains (Rₑ)], each chain (Rₑ) comprising a group selected from the group consisting of silane-containing group, acid group and derivatives thereof;
wherein said chains (Rₑ) are linked to opposite sides of said (R_{pf}) via a sigma bond.

15. The article according to claim 1, wherein (per)fluoropolyether polymer is Fluorolink® F10 and Fluorolink® S10.

16. The article according to claim 1, wherein the weight ratio of (per)fluoropolyether polymer is comprised between 1% and 30% based on total weight of the composition of functional coating film.

17. The article according to claim 1, wherein the mean roughness (Ra) of the functional coating film is comprised between 5 nm and 250 nm and Z-Range is comprised between 200 nm and 750 nm.

18. The article according to claim 1, wherein the root mean roughness (Rq) of the functional coating film is comprised between 5 nm and 250 nm and Z-Range is comprised between 200 nm and 750 nm.

19. A process for the manufacture of an article comprising a coated substrate, comprising steps of:
(i) Contacting at least an area of the surface of the substrate with a composition (b) comprising solid particle B source, optionally in admixture with a PFPE polymer,
(ii) Drying and optionally curing the layer obtained in step (i),
(iii) Contacting the layer obtained in step (ii) with a composition (a) comprising solid A source, optionally in admixture with a PFPE polymer,
(iv) Drying and optionally curing the layer obtained in step (iii),
(v) Optionally contacting the surface the article obtained in step (iv) with a composition (c) comprising at least one PFPE polymer,
(vi) Optionally drying and/or curing the layer obtained in step (v), provided that composition (a) comprises a PFPE polymer when step (v) and (vi) are not comprised.

20.-29. (canceled)

30. An article obtained by the process according to claim 19.
